(19) United States
(12) Patent Application Publication
(10) Pub. No.: US 2024/0377514 A1
(43) Pub. Date: Nov. 14, 2024

(54) LONG RANGE COHERENT LIDAR

(71) Applicant: INTEL CORPORATION, Santa Clara, CA (US)

(72) Inventors: Shachar GREENBERG, Nofit (IL); Yaakov VILENCHIK, Menlo Park, CA (US); Eyal YAIR, Givat Ela (IL); Naresh SATYAN, Pasadena, CA (US)

(21) Appl. No.: 18/552,928

(22) PCT Filed: Mar. 25, 2022
(86) PCT No.: PCT/US2022/021839

§ 371 Date: Sep. 28, 2023

Related U.S. Application Data
(60) Provisional application No. 63/194,217, filed on May 28, 2021.

(51) Int. Cl. G01S 7/4911; G01S 7/493; G01S 7/497; G01S 17/34; G01S 17/93

(52) U.S. Cl. CPC G01S 7/4911; G01S 7/493; G01S 7/497; G01S 17/34; G01S 17/93

(57) ABSTRACT

A light detection and ranging system is provided, which includes an output to output coherent laser light; an optical frequency discriminator configured to apply optical frequency discrimination to a portion of the coherent laser light to generate frequency discriminated laser light; and a processor configured to determine laser phase noise in the frequency discriminated laser light; to determine a laser phase noise compensation using the determined laser phase noise; and to apply the laser phase noise compensation to a received light signal corresponding to the output coherent laser light.

### CROSS-REFERENCE

This PCT application claims priority to U.S. provisional application 63/194,217, filed on May 28, 2021, the entirety of which is fully incorporated herein by reference.

### TECHNICAL FIELD

This disclosure relates generally to long range coherent light detection and ranging (LIDAR) systems.

### BACKGROUND

Long range coherent light detection and ranging usually uses laser source(s) with coherent-length much larger than the desired LIDAR range. This translates to the deployment of very narrow-linewidth lasers. In addition, those narrow-linewidth lasers usually require noise-superior drivers and power-supplies, specialized sealed packages and tight temperature control. This in turn, yields a bulky, expensive, rare, and temperature-sensitive laser source systems for any coherent LIDAR application that targets ranges more than few tens of meters.

Coherent LIDAR usually requires precise control over the phase modulation, which often results in either performance degradation (reduced range) or complicated and costly systems (e.g., feedback, external modulation).

The common coherent LIDAR uses two-chirp frequency-modulated continuous-wave (FMCW), suffers from range-velocity ambiguity where two range-velocity pairs are ambiguous and cannot be easily resolved.

A traditional approach to the coherence problem is to employ very narrow-linewidth lasers, carefully packaged and controlled by practically noise-less drivers and quiet power-supplies. This approach (narrow-linewidth lasers) yield expensive and bulky LIDAR systems due to the stringent laser, package and driver requirements. This historically limited the usage of coherent long-range LIDARs to space, weather and military applications. In contrast automotive applications call for large-scale and cost-effective solutions to be viable.

Another approach to the coherence problem is a precise control of the laser chirp modulation (also denoted as chirp linearization) in short-range applications (e.g., optical-coherent-tomography) which typically uses K-clocks based on optical frequency discriminators such as Mach-Zehnder interferometers (via heterodyne or homodyne detection) to sample the data. While this approach is hardly used for long-range LIDAR applications, it does provide FMCW chirp linearization and laser frequency noise reduction over a narrow band, and thus is mentioned here. In addition, precise modulation has been obtained using control-loops, external modulation, precise pre-distortion signal, and post-processing. This approach (K-clock based sampling) fails to address one inherent aspect of automotive LIDAR (and all dynamic/in-motion LIDARs/scene)-Doppler shift due to relative velocity between LIDAR platform and ranging target. Whereas K-clock sampling corrects chirp non-linearities and slow frequency noise in stationary LIDAR targets by re-sampling the data, it adversely corrupts the signal in moving targets due to Doppler-shift. This makes the K-clock method unsuitable for automotive applications where practically all targets in the scene are moving and induce Doppler shifts. Other methods such as control loops and external modulation systems result in more complex LIDAR systems.

The ambiguity issue may be resolved using an additional chirp/waveform, coding or frequency offset using external modulation or external laser source. The previous solutions for this topic (ambiguity) extract a toll on the link-budget (range-performance), or on the complexity/cost of the system.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 illustrates a schematic diagram of a vehicle having a LIDAR system;

FIG. 2 shows a portion of a LIDAR system;

FIG. 3 shows a portion of a LIDAR system;

FIG. 4 shows a portion of a LIDAR system;

FIG. 5 shows a range diagram of a laser;

FIG. 6 shows a range diagram of a laser;

FIG. 7 shows a portion of a LIDAR system;

FIG. 8 shows a frequency diagram;

FIG. 9A shows a frequency diagram;

FIG. 9B shows a frequency diagram; and

FIG. 10 shows a portion of a LIDAR system.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

This disclosure provides a long range (and e.g. unambiguous) coherent light detection and ranging (LiDAR) system based on broad-linewidth lasers using optical frequency discriminator reference and post-processing.

Illustratively, a LIDAR system may be provided, which includes a laser source, which may be tapped into an optical frequency discriminator, detected, and sampled. Using digital processing techniques of phase estimation, the phase noise of the laser may be measured. Post processing may be applied to correct for laser phase-noise and modulation non-idealities, while keeping the Doppler signal uncorrupted, and resolving the range-velocity ambiguity.

A provided LIDAR system may improve the coherence (linewidth) of the laser source, or the precision of the modulation, and therefore may improve the detectability of targets, as well as reducing measurements errors, all while using standard cost-effective laser sources, and modulation schemes. This may result in LIDAR ranging performance equivalent to the performance that would have been achieved with expensive narrow-linewidth lasers, but using cost-effective standards lasers. In addition the resolution of the ambiguity improve performance without significant cost increase, and simplifies the system design.

Automotive self-driving and advanced (ADAS) applications require a LIDAR system that provides long-range (>200 m), high data rate (>1 MSPS) and immunity to interference from neighboring LIDAR systems and ambient light. Among other preferable qualities, coherent LIDAR provides inherent and superior immunity to interference and to ambient light. In addition, coherent LIDAR is the only LIDAR technology that can provide instantaneous velocity information from every pixel. These characteristics make a coherent LIDAR technology advantageous for automotive applications.

Coherent LIDAR technology was considered complex and costly, and was usually limited to few niche applications. Long-range coherent LIDAR systems were mostly used in space, military, and weather applications, while short-range coherent LIDAR systems were mostly used in medical applications. One of the main reasons coherent LIDAR systems were not commercialized for the consumer or automotive markets, was the stringent requirement for the laser source—Efficient Long-range LIDAR applications require laser sources with superior phase-noise characteristics. This stringent requirement for the laser source yielded increased LIDAR system cost, complexity, and supply-chain challenges.

An additional requirement for coherent LIDAR laser source is a precise control over the frequency modulation waveform. For example, coherent FMCW LIDAR requires precise linear frequency chirps. Other frequency or phase encoding techniques for a LIDAR system are also possible, and this disclosure may be adapted to more complex modulation waveforms, but this disclosure, as an example, provides linear optical frequency chirps for simplicity. Any deviation from linearity in a linear chirp FMCW LIDAR system would translate to range-performance degradation. This challenge is often addressed using control-loops, external modulation, precise pre-distortion signal, and post-processing. Among these approaches, post-processing benefits from being very cost-effective and robust. A common post-processing solution is to sample or re-sample the signal using a clock that indicate and follows the laser frequency evolution. This is referred to as K-Clock sampling, and is common in short-range applications for chirp-linearization.

The problem of laser phase-noise and the challenge of precise waveform control (e.g., chirp-linearization) are closely related—deviation from the precise waveform (e.g., chirp non-linearities) adds phase-noise to the received LIDAR beat signal in the same way that laser phase-noise does. In fact, when the laser is being modulated, it is very difficult to distinguish between laser phase-noise and waveform errors. Thus, they will be treated the same and be referred to as laser-phase-noise.

Automotive LIDAR poses a new challenge for post-processing of coherent LIDAR signal. The received beat signal is composed of two non-correlated terms:
1) A sinusoidal signal (also denoted as phasor) in which the range information is coded. This signal suffers from laser phase noise and chirp non-idealities.
2) A frequency offset of the phasor in which the relative velocity between the target and the LIDAR system (Doppler) information is coded. To first order, this signal behaves as a constant frequency offset and is not corrupted by the laser modulation errors.

In automotive applications wide range of velocities exist in almost any scene. A challenge posed by this application is that any traditional solution (e.g., k-clock sampling) to correct in post processing for phase-noise (and non-linearities) would corrupt the Doppler signal. The fact that the Doppler and range are intertwined in the signal requires a new approach.

This disclosure is focused in several areas, which will be described in more detail below:
1) The design of a LIDAR system that allows usage of standard cost effective lasers.
2) The design of a LIDAR system without the need for ultra-precise control of the LIDAR waveform, while not suffering performance degradation due to modulation errors.
3) The post-processing approach that allows full reconstruction of the signal, despite the degradation due to phase-noise and non-linearities, and in the presence of Doppler shift.
4) This approach also provides a method to resolve a common ambiguity problems in coherent LIDAR.

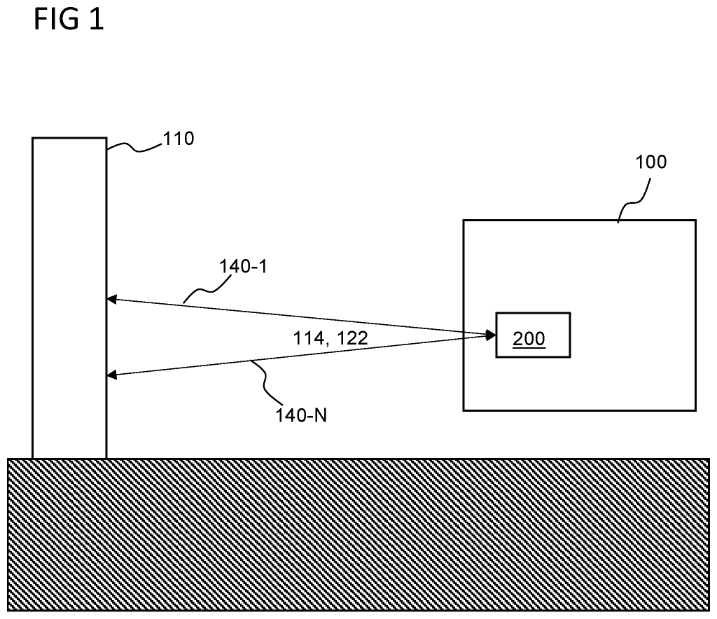

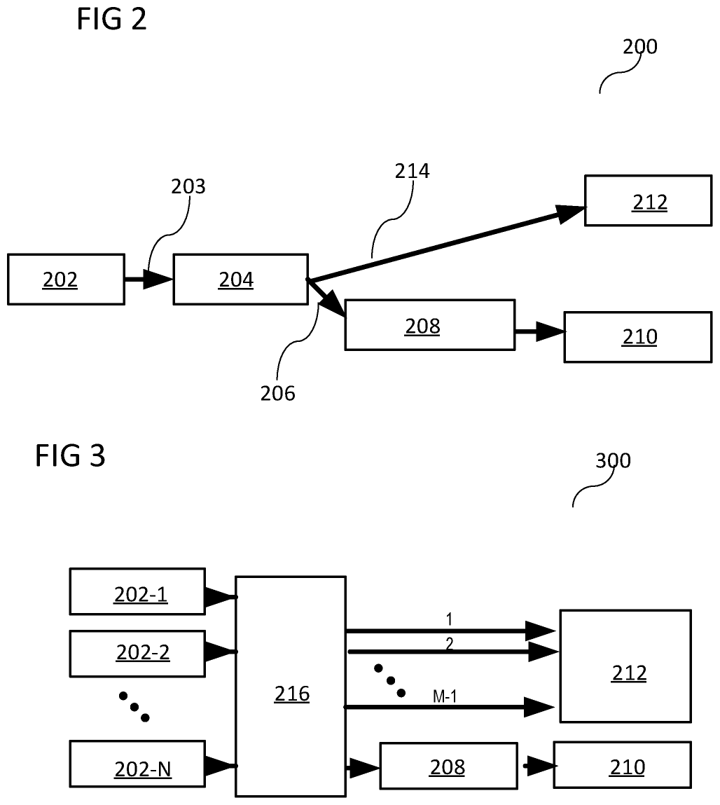

FIG. 1 illustrates a schematic diagram of a vehicle 100 having a LIDAR system 200 integrated therein, as an example. The vehicle 100 may be an unmanned vehicle, e.g. unmanned aerial vehicle or unmanned automobile. The vehicle 100 may be an autonomous vehicle. Here, the LIDAR system 200 may be used to control the direction of travel of the vehicle 100. The LIDAR system 200 may be configured for obstacle detection outside of the vehicle 100, as an example. Alternatively or in addition, the vehicle 100 may require a driver to control the direction of travel of the vehicle 100. The LIDAR system 200 may be part of a driving assistant. As an example, the LIDAR system 200 may be configured for obstacle detection, e.g. determining a distance and/or direction and relative velocity of an obstacle (target 110) outside of the vehicle 100. The LIDAR system 200 may be configured, along one or more light paths 140-i (with i being an integer between 1 and N), to emit light 114 from one or more outputs Tx of the LIDAR system 200 and to receive light 122 reflected from the target 110 in one or more light inputs Rx of the LIDAR system 200 (see also FIG. 2). Alternatively, the LIDAR system 200 may be or may be part of a spectrometer or microscope.

FIG. 2 shows a portion of a LIDAR system, e.g. of the LIDAR system 200. This example of a LIDAR system design includes at least one low-cost, broad linewidth laser source 202.

The laser source(s) 202 (in other word laser light 203 emitted by the laser source(s) 202) are tapped (by means of an optical tap circuit 204) and a portion of the light 206 goes through an optical frequency discriminator 208. For example, an unbalanced Mach-Zehnder interferometer (MZI) could be used as the optical frequency discriminator 208. The optical frequency/phase is detected and sampled (e.g. in a detection and sampling circuit 210 of the LIDAR system 200). This path with the optical frequency discriminator 208 and detection/sampling hardware 210 will be referred to as the optical reference path, and the resultant sampled signal is the reference signal.

A LIDAR engine 212 of the LIDAR system 200 is provided to launch the laser light 214 to a scene, to receive the reflected light, and to output an electrical signal that embeds the information on range/velocity of the target. The LIDAR engine 212 could use the laser source(s) 202 shown above or could use a different laser source or could have an additional laser source(s). It could embed optical mixer, detector, amplifier, optics, any polarization handling components or any other element required for LIDAR.

An example 300 of the above design is shown in FIG. 3 for the case of several lasers sources (e.g. Laser Source 1 202-1, Laser Source 2 202-2, . . . , Laser Source N 202-N), which may be multiplexed on a single LIDAR PIC (Photonic Integrated Circuit) by a coupler 216. The coupler 216 may be N×M coupler distributing N Laser sources into M−1 optical waveguides 1, 2, M−1 to the LIDAR Engine 212, and one waveguide of the M waveguides to the optical frequency discriminator 208 coupled to the detection and sampling circuit 210.

The sampled reference signal from the optical reference path is used for post-processing of the target signal received from the LiDAR engine to correct for laser phase noise and non-linearities, and resolve target range-velocity ambiguities.

Unlike the K-Clock sampling approach, where the sampled signal is used to resample the received data, this approach is different. First, two important observations for long range coherent applications should be noted:
1) Laser phase-noise degrades the performance of LIDAR ranging only at ranges above certain range. This range is related to the laser coherence length. Thus, short to medium ranges will be less affected from laser phase-noise if the range is much shorter than the laser coherence length.
2) The phase of the interferometric LIDAR signal, ϕₛ is of the form:

$${ϕ}_{s} ( t ) = {ϕ}_{l} ( t ) - {ϕ}_{l} ( t - τ )$$

where ϕₗ is the laser's phase noise. This delayed self-interferometric signal yields received signal that are being filtered at frequencies larger than the interferometer FSR f>1/τ. This limits the frequency content of adverse phase noise. Thus, relevant frequency band for phase noise for long range targets (large τ) is typically narrow. This disclosure also applies to cases where the detected optical phase include signals from different lasers. For example:

$${ϕ}_{s} ( t ) = {ϕ}_{l 1} ( t ) - {ϕ}_{l 2} ( t - τ )$$

where ϕ_{l1,2} are phases of laser1 and laser2 respectively.

The conclusion from these two observations is that high-frequency phase-noise is only of interest for short-range targets, where performance is not degraded anyway. At long-ranges, mostly low-frequency phase noise is of interest.

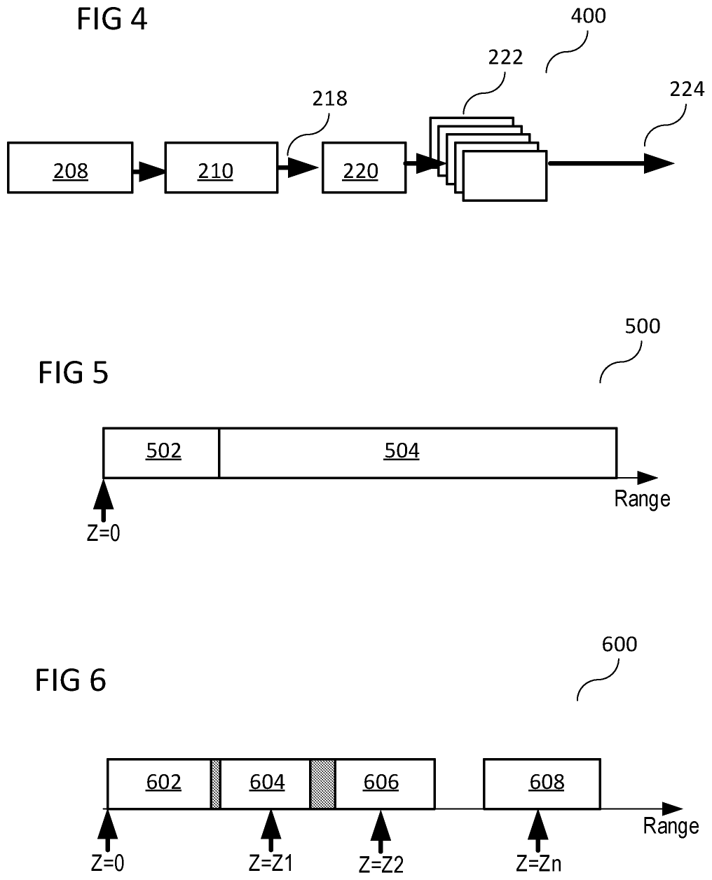

The sampled signal 218 is being processed using phase-estimation techniques (as illustrated in a portion 400 of the LIDAR system 200 in FIG. 4). As mentioned above, due to the unique long-range LIDAR signal, the phase-estimation does not necessarily have to be broad-band, and thus could have relaxed requirements on the bandwidth of the frequency discriminator, detector and sampling, which makes this invention very practical.

The phase noise correction and range-velocity disambiguation process is shown in FIG. 4 above. The respective processes are:
1) The reference signal is sampled and the phase of the sampled signal is extracted.
2) The output of the phase-estimation is determined by the transfer function of the discriminator, detector and sampler. The impact of this transfer function is compensated by using an inverse filter 220 or inverse correction function.
3) Then a series of N filters 222 (or functions) processes the corrected signal. Each filter 222 is optimized for a specific range Zi, i=1, 2, . . . N.
4) The N correction waveform 224, which is also referred to as range hypothesis bank, is applied as a multiplicative phase correction (this is not a resampling):

$$r {x}_{corrected , i} = F ( r x , {Δϕ}_{Zi} )$$

where rx is the target signal received from the LIDAR engine 212 (which has range and Doppler information encoded in it), Δϕ_{Zi} is the correction that was optimized for range Zᵢ, or optimized for some finite range around Zᵢ. F is a general function chosen for optimization. One possible choice of function is

$$F = 〈 r x , {e}^{- j Δϕ Zi ( t )} 〉 = rx \cdot {e}^{- j △ ϕ Zi ( t )}$$

5) The output of this N hypothesis bank 224 is processed to detect range and velocity. An enhancement in performance is achieved when the actual measured range (Z) is close to the hypothesis (Zᵢ). Other hypotheses far from the true range Z result in poorer performance of the hypothesis.
6) In an alternative, the enhancement in the performance is optimized for an arbitrary desired criterion (and not limited to maximizing the signal). Thus, for the correct filter from the filter bank the signal will be optimized and will have the same performance as if a laser with a much better coherence (linewidth) was used to perform the LIDAR measurements.

When the range hypothesis is close to the real targets range, the accumulated phase-noise is effectively suppressed. Any range around the hypothesis-range that is within the coherence length of the laser source 202 will yield high performance LIDAR signal, despite the fact that the range itself could be outside the coherence length of the laser. A standard laser without the features of this disclosure would have high performance within the coherence length (first range 502), and low performance outside the coherence length (second range 504), as shown in a first range diagram 500 in FIG. 5.

In the LIDAR system 200 of this disclosure, the range hypothesis bank allows the LIDAR system 200 to replicate it high performance regime to other ranges, as shown in a second range diagram 600 in FIG. 6 (first range 602, second range 604, third range 606, n-th range 608).

Depending on the range hypothesis bank {Z₀ . . . Z_{N}}, the high-performance range can extend to long ranges, can overlap, or be isolated around some region of interest. It can also be seen from the above, that there is a relation between the inherent laser phase noise (or modulation non-idealities) and the number of range-hypothesis bank filters 222 provided to cover a long range. For a given desired efficient range more filters 222 are provided if the linewidth of the laser is broad. Consequently, if the linewidth of the laser (e.g. the laser source 202) is broader, more filters 222 are provided. An example may have constant range hypothesis bank 222, or could have a dynamic hypothesis bank 222, where the number N of filters 222 in the bank 222, or the shapes of the filters 222 can be changed in response to additional information from the LIDAR engine 212, the target application, or the LIDAR scene. Examples of the hypothesis bank 222 are: an iterative hypothesis bank 222; a random bank 222; a scene-based bank 222 depending on known targets in the scene or the expected targets in the scene; a history-based bank 222 depending on previous LIDAR measurements and supported by tracking information or prior knowledge and application specific.

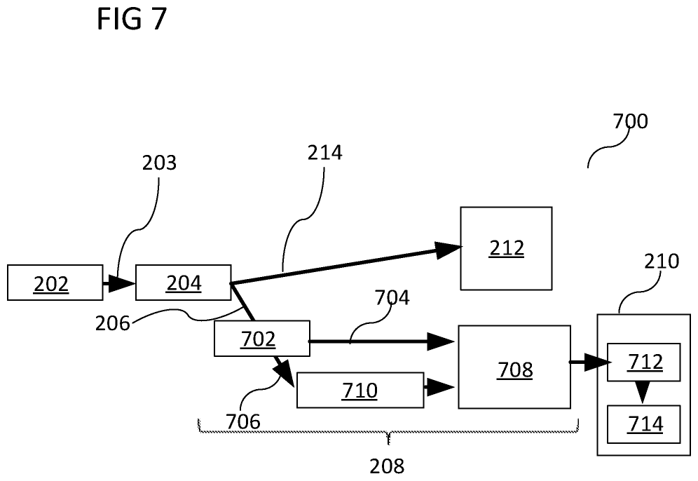

An example 700 provides an FMCW (e.g., linear chirp). In this example 700, the LIDAR system 200 includes an unbalanced MZI acting as the optical frequency discriminator 208, with a single laser as the laser source 202, as shown in FIG. 7. The MZI-based optical frequency discriminator 208 may include an optical splitter 702 coupled downstream to the optical tap circuitry 204, a first light signal path 704 and a second light signal path 706. The MZI-based optical frequency discriminator 208 may further include an optical mixer (coupler) 708. The optical mixer 708 may be directly coupled downstream to one output of the optical splitter 702 via the first light signal path 704 and, via a delay line element 710, which may be inserted into the second light signal path 706, and thus the second light signal path 706 to another output of the optical splitter 702. Thus, light output by the optical splitter 702 and propagating via the second light signal path 706 will arrive later at the optical mixer 708 then light output by the optical splitter 702 and propagating via the first light signal path 704 (due to the delay line 710 in the light second light signal path 706).

Furthermore, the detection and sampling circuit 210 may include one or more photo diodes 712 coupled downstream to the optical mixer 708, and a sampling circuit 714 coupled downstream to the one or more photo diodes 712.

The sampled reference signal from the one or more photo diodes 712 in FIG. 7 is processed and its phase is extracted. The phase extraction could be done using any phase-estimation technique (e.g. including but not limited to phase locked look (PLL), zero-crossing, fast Fourier transformation (FFT)-based, etc. . . . ). Usually the SNR is high in the optical reference path (e.g. the first light signal path 704), and the phase-estimation has very low error.

The extracted phase Δϕ(n) is passed through the inverse filter. The digital inverse filter for this embodiment could take the form:

$${H}_{inverse} ( z ) = \frac{1}{1 - A {z}^{- M 1} - B {z}^{- M 2}}$$

where A, B, M₁, M₂ are parameters chosen based on the details of the MZI delay and the properties of the sampler (e.g. the sampling circuit 714).

The digital hypothesis filter for range Zᵢ could take the form:

$${H}_{Zi} = 1 - {C}_{i} {z}^{- Li} - {D}_{i} {z}^{- Ri}$$

where Cᵢ, Dᵢ, Lᵢ, Rᵢ are chosen based on the details of the sampling process and the hypothesis range Zᵢ. These parameters are unique and optimized to correct phase error for range Zᵢ.

The correction is calculated via the digital filters:

$${Δϕ}_{Zi} ( s ) = {H}_{Z K} ( s ) {H}_{inverse} ( s ) Δϕ ( s )$$

An alternative could take the form:

$${Δϕ}_{Zi} ( s ) = F ( Δϕ ( s ) , {Z}_{i} )$$

where F is a general function, and s is the Z-transform or Laplace-transform variable.

The set of corrections from the hypothesis bank 222 is applied to the received LIDAR signal rx (with unknown target at unknown range/velocity) to generate a set of corrected signals rx_corrected,i, each optimized to a particular range Zi. For example:

$$r {x}_{corrected , i} = rx \cdot {e}^{j △ ϕ Zi ( n )}$$

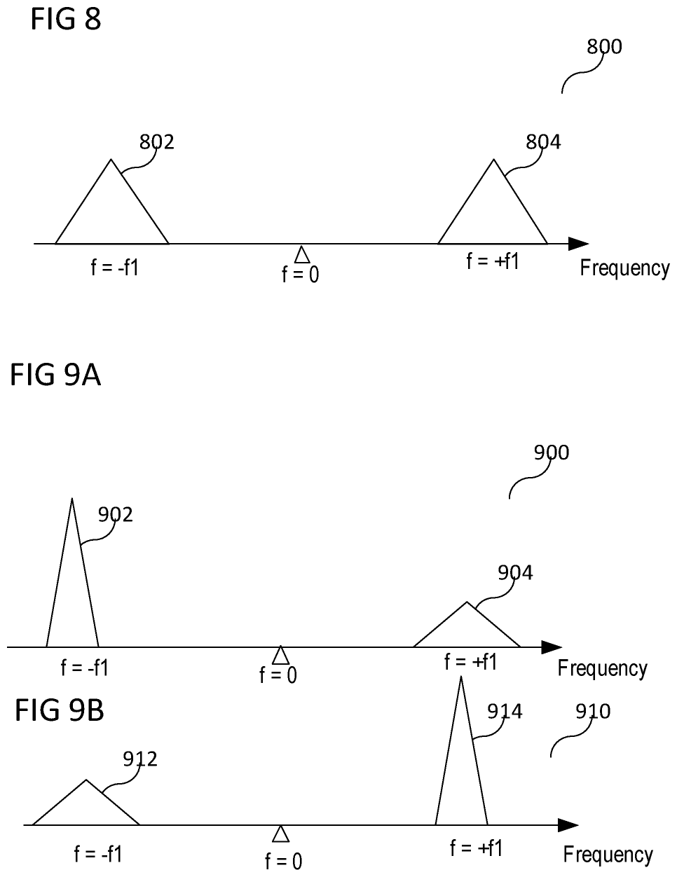

When the Rx signal is detected in the LIDAR engine 212 without IQ demodulation (most common implementation) there is a range-Doppler ambiguity. This usually occurs in FMCW LIDAR. The conventional FMCW technique of two-chirps (up/down, or other combination) suffers from ambiguity since two solutions (two range-velocity pairs) are ambiguous. This often requires additional chirp or other dis-ambiguity methods that often extract a toll on the link-budget. The method described in this disclosure may resolve that ambiguity. The Real signal portion (before any correction) has two identical sidebands 802, 804, as shown in a frequency diagram 800 in FIG. 8, e.g. a negative sideband 802 at a frequency of “−f1”, and a positive sideband 804 at a frequency of “+f1” relative to a center frequency “f=0”). Due to phase-noise or non-linearities, the two sidebands are corrupted/degraded. The degradation is the same for both sidebands.

The (complex signal portion) correction in this disclosure may be applied. However, it improves/corrects only one of these sidebands. The other sideband is in fact degraded even further (see e.g. negative sideband 902 at “−f1”, and positive sideband 904 at “+f1” in a first frequency diagram 900 in FIG. 9A and negative sideband 912 at “−f1”, and positive sideband 914 at “+f1” in a second frequency diagram 910 in FIG. 9B).

By identifying which sideband 902, 904, 912, 914 was improved, the ambiguity is resolved. Thus, this process results in an unambiguous solution (range, velocity pair).

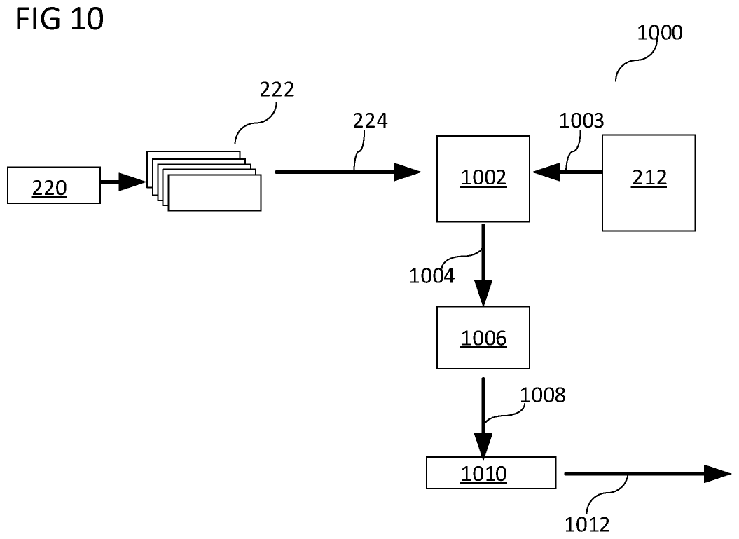

The corrected signal is further processed. An example 1000 of this processing could have the form as shown in FIG. 10.

LIDAR engine 212 provides a received signal 1003 to a correction circuit 1002 (also denoted as uncorrected signal 1003), which also receives the N correction waveforms 224, as described above. Using the N correction waveforms 224 and the received signal 1003, the correction circuit 1002 determines N corrected signals 1004 and provides them to a LIDAR signal processing circuit 1006, which processes the N corrected signals 1004 to generate N solutions 1008. A selection circuit 1010 selects one of the N corrected signals 1004 and outputs the selected corrected signal 1004 as a single unambiguous solution 1012 for further processing, e.g. to be used for controlling the vehicle 100 (see FIG. 1).

Resulting in an unambiguous solution 1012, with performance equivalent to the one achieved using narrow-linewidth laser and ultra precise modulation. Thus, even though the LIDAR system 200 had used an inferior laser (broad linewidth) and non-precise modulation/chirp (e.g., non-linear) that would otherwise resulted in extreme performance degradation, and possible ambiguity, the ideal performance is extracted, and the ambiguity resolved. The scheme could be generalized to optimize power-consumption, compute power, or others, by optimizing the number and shape of correction waveforms 224 in the hypothesis bank 222, using a different selection function to pick the optimum corrected signal, or other examples within the same framework. The disclosure is not limited to the above examples.

In other words, referring to FIG. 1 to FIG. 10, a LIDAR system 200 may include means for determining laser phase noise in a frequency discriminated laser light determined by applying optical frequency discrimination to a portion of a coherent laser light of coherent laser light output by a LIDAR system 200; means for determining a laser phase noise compensation using the determined laser phase noise; means for applying the laser phase noise compensation to a light signal received by the light detection. Illustratively, the LIDAR system 200 may include an output Tx to output coherent laser light; an optical frequency discriminator 208 configured to apply optical frequency discrimination to a portion of the coherent laser light to generate frequency discriminated laser light; and a processor. The processor may be configured to determine laser phase noise in the frequency discriminated laser light; determine a laser phase noise compensation using the determined laser phase noise; apply the laser phase noise compensation to a received light signal corresponding to the output coherent laser light.

The compensation may be performed in the digital domain of the processing (also denoted as post-processing), e.g. after detecting received light in the photo diode (also denoted as received light). This way bandwidth limitation may be avoided in the LIDAR system 200.

The processor may be configured to determine the laser phase noise compensation by applying a first filter function implementing the inverse characteristic of the optical frequency discriminator 208 to provide a pre-compensation signal. Alternatively, or in addition, the processor may be configured to determine the laser phase noise compensation by further applying a series of a plurality of second filter functions to the pre-compensation signal. Each second filter function may describe the characteristic of the light transmission in a predefined distance from the output of the LIDAR system 200 to generate distance specific compensation signals. The processor may be further configured to apply the laser phase noise compensation by applying at least one of the distance specific compensation signals to the received light signal.

The laser phase noise compensation may include determining a plurality of distance specific compensated received light signals. The processor may be configured to select a distance specific compensated received light signal from the plurality of distance specific compensated received light signals.

The LIDAR system may include at least one laser source configured to generate the coherent laser light. The at least one laser source may include at least one frequency modulated continuous wave laser source. Alternatively, or in addition, the at least one laser source may include a plurality of laser sources. The LIDAR system 200 may further include an optical coupler to provide a plurality of coherent laser light beams to output as the coherent laser light and to provide the portion of the coherent laser light to the optical frequency discriminator 208.

The optical frequency discriminator 208 may include a Mach-Zehnder interferometer based discriminator.

A receiver may be configured to receive a light signal. The receiver may include a photo diode 712.

A computer readable medium may have instructions stored therein that, when executed by one or more processors, cause the processor to: determine laser phase noise in a frequency discriminated laser light determined by applying optical frequency discrimination to a portion of a coherent laser light of coherent laser light output by a LIDAR system 200; determine a laser phase noise compensation using the determined laser phase noise; apply the laser phase noise compensation to a light signal received by the LIDAR system 200 corresponding to the output coherent laser light.

The laser phase noise compensation may be determined by applying a first filter function implementing the inverse characteristic of the optical frequency discriminator 208 to provide a pre-compensation signal. The laser phase noise compensation may further apply a series of a plurality of second filter functions to the pre-compensation signal, each second filter function describing the characteristic of the light transmission in a predefined distance from the output of the LIDAR system 200 to generate distance specific compensation signals. The laser phase noise compensation may be applied by applying at least one of the distance specific compensation signals to the received light signal.

The laser phase noise compensation may include determining a plurality of distance specific compensated received light signals. The computer readable medium may further have instructions stored therein that, when executed by one or more processors, cause the processor to select a distance specific compensated received light signal from the plurality of distance specific compensated received light signals.

In the following, various examples are provided that may include one or more aspects described above.

Example 1 is a light detection and ranging system, including: an output to output coherent laser light; an optical frequency discriminator configured to apply optical frequency discrimination to a portion of the coherent laser light to generate frequency discriminated laser light; a processor configured to determine laser phase noise in the frequency discriminated laser light; determine a laser phase noise compensation using the determined laser phase noise; apply the laser phase noise compensation to a received light signal corresponding to the output coherent laser light.

In Example 2, the subject matter of Example 1 can optionally include that the processor is configured to determine the laser phase noise compensation by applying a first filter function implementing the inverse characteristic of the optical frequency discriminator to provide a pre-compensation signal.

In Example 3, the subject matter of Example 2 can optionally include that the processor is configured to apply a series of a plurality of second filter functions to the pre-compensation signal, each second filter function describing the characteristic of the light transmission in a predefined distance from the output of the light detection and ranging system to generate distance specific compensation signals. The processor is further configured to apply the laser phase noise compensation by applying at least one of the distance specific compensation signals to the received light signal.

In Example 4, the subject matter of any one of Examples 1 to 3 can optionally include at least one laser source configured to generate the coherent laser light.

In Example 5, the subject matter of Example 4 can optionally include that the at least one laser source includes at least one frequency modulated continuous wave laser source.

In Example 6, the subject matter of any one of Examples 4 or 5 can optionally include that the at least one laser source includes a plurality of laser sources; the light detection and ranging system further including an optical coupler to provide a plurality of coherent laser light beams to output as the coherent laser light and to provide the portion of the coherent laser light to the optical frequency discriminator.

In Example 7, the subject matter of any one of Examples 1 to 6 can optionally include that the optical frequency discriminator includes a Mach-Zehnder interferometer based discriminator.

In Example 8, the subject matter of any one of Examples 1 to 4 can optionally include a receiver configured to receive a light signal.

In Example 9, the subject matter Example 8 can optionally include that the receiver includes a photo diode.

In Example 10, the subject matter of any one of Examples 3 to 9 can optionally include that the laser phase noise compensation includes determining a plurality of distance specific compensated received light signals.

In Example 11, the subject matter of Example 10 can optionally include that the processor is further configured to select a distance specific compensated received light signal from the plurality of distance specific compensated received light signals.

Example 12 is a computer readable medium having instructions stored therein that, when executed by one or more processors, cause the processor to: determine laser phase noise in a frequency discriminated laser light determined by applying optical frequency discrimination to a portion of a coherent laser light of coherent laser light output by a light detection and ranging system; determine a laser phase noise compensation using the determined laser phase noise; apply the laser phase noise compensation to a light signal received by the light detection and ranging system corresponding to the output coherent laser light.

In Example 13, the subject matter of Example 12 can optionally include that the laser phase noise compensation is determined by applying a first filter function implementing the inverse characteristic of the optical frequency discriminator to provide a pre-compensation signal.

In Example 14, the subject matter of Example 13 can optionally include that the laser phase noise compensation is determined by further applying a series of a plurality of second filter functions to the pre-compensation signal, each second filter function describing the characteristic of the light transmission in a predefined distance from the output of the light detection and ranging system to generate distance specific compensation signals. The laser phase noise compensation is applied by applying at least one of the distance specific compensation signals to the received light signal.

In Example 15, the subject matter of Example 14 can optionally include that the laser phase noise compensation includes determining a plurality of distance specific compensated received light signals.

In Example 16, the subject matter of Example 15 can optionally include instructions stored therein that, when executed by one or more processors, cause the processor to select a distance specific compensated received light signal from the plurality of distance specific compensated received light signals.

Example 17 is a vehicle including a light detection and ranging system according to any one of Examples 1 to 11.

Example 18 is a sensor system including a light detection and ranging system according to any one of Examples 1 to 11.

Example 19 is a light detection and ranging system, including: means for determining laser phase noise in a frequency discriminated laser light determined by applying optical frequency discrimination to a portion of a coherent laser light of coherent laser light output by a light detection and ranging system; means for determining a laser phase noise compensation using the determined laser phase noise; means for applying the laser phase noise compensation to a light signal received by the light detection and ranging system corresponding to the output coherent laser light.

Another example uses a deliberate modulation on top of the LiDAR modulation (linear chirp in the example in this disclosure). Without any correction, this additional deliberate modulation would result in degradation or corruption of the signal. With the proposed solution described in this invention disclosure, performance is restored. This could be used for example for disambiguation of targets, for detection of multiple targets in the same LIDAR spot/pixel, for spur cancellation or other purpose.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A light detection and ranging system, comprising:
an output to output coherent laser light;
an optical frequency discriminator configured to apply optical frequency discrimination to a portion of the coherent laser light to generate frequency discriminated laser light; and
a processor configured to
determine laser phase noise in the frequency discriminated laser light;
determine a laser phase noise compensation using the determined laser phase noise; and
apply the laser phase noise compensation to a received light signal corresponding to the output coherent laser light.

2. The light detection and ranging system of claim 1,
wherein the processor is configured to determine the laser phase noise compensation by applying a first filter function implementing the inverse characteristic of the optical frequency discriminator to provide a pre-compensation signal.

3. The light detection and ranging system of claim 2,
wherein the processor is configured to apply a series of a plurality of second filter functions to the pre-compensation signal, each second filter function describing the characteristic of the light transmission in a predefined distance from the output of the light detection and ranging system to generate distance specific compensation signals;
wherein the processor is further configured to apply the laser phase noise compensation by applying at least one of the distance specific compensation signals to the received light signal.

4. The light detection and ranging system of claim 1, further comprising:
at least one laser source configured to generate the coherent laser light.

5. The light detection and ranging system of claim 4, further comprising:
wherein the at least one laser source comprises at least one frequency modulated continuous wave laser source.

6. The light detection and ranging system of claim 4, further comprising:
wherein the at least one laser source comprises a plurality of laser sources;
the light detection and ranging system further comprising an optical coupler to provide a plurality of coherent laser light beams to output as the coherent laser light and to provide the portion of the coherent laser light to the optical frequency discriminator.

7. The light detection and ranging system of claim 1,
wherein the optical frequency discriminator comprises a Mach-Zender interferometer based discriminator.

8. The light detection and ranging system of claim 1, further comprising:
a receiver configured to receive a light signal.

9. The light detection and ranging system of claim 8, further comprising:
wherein the receiver comprises a photo diode.

10. The light detection and ranging system of claim 1,
wherein the processor is configured to determine the laser phase noise compensation by applying a first filter function implementing the inverse characteristic of the optical frequency discriminator to provide a pre-compensation signal;
wherein the laser phase noise compensation comprises determining a plurality of distance specific compensated received light signals.

11. The light detection and ranging system of claim 10,
wherein the processor is further configured to select a distance specific compensated received light signal from the plurality of distance specific compensated received light signals.

12. A non-transitory computer readable medium having instructions stored therein that, when executed by one or more processors, cause the processor to:
determine laser phase noise in a frequency discriminated laser light determined by applying optical frequency discrimination to a portion of a coherent laser light of coherent laser light output by a light detection and ranging system;
determine a laser phase noise compensation using the determined laser phase noise;
apply the laser phase noise compensation to a light signal received by the light detection and ranging system corresponding to the output coherent laser light.

13. The non-transitory computer readable medium of claim 12,
wherein the laser phase noise compensation is determined by applying a first filter function implementing the inverse characteristic of the optical frequency discriminator to provide a pre-compensation signal.

14. The non-transitory computer readable medium of claim 13,
wherein the laser phase noise compensation is further determined by applying a series of a plurality of second filter functions to the pre-compensation signal, each second filter function describing the characteristic of the light transmission in a predefined distance from the output of the light detection and ranging system to generate distance specific compensation signals;
wherein the laser phase noise compensation is applied by applying at least one of the distance specific compensation signals to the received light signal.

15. The non-transitory computer readable medium of claim 14,
wherein the laser phase noise compensation comprises determining a plurality of distance specific compensated received light signals.

16. The non-transitory computer readable medium of claim 15,
further comprising instructions stored therein that, when executed by one or more processors, cause the processor to select a distance specific compensated received light signal from the plurality of distance specific compensated received light signals.

17. A vehicle comprising a light detection and ranging system, the light detection and ranging system, comprising:
an output to output coherent laser light;
an optical frequency discriminator configured to apply optical frequency discrimination to a portion of the coherent laser light to generate frequency discriminated laser light;
a processor configured to
determine laser phase noise in the frequency discriminated laser light;
determine a laser phase noise compensation using the determined laser phase noise;
apply the laser phase noise compensation to a received light signal corresponding to the output coherent laser light.

18. The vehicle of claim 17,
wherein the processor is configured to determine the laser phase noise compensation by applying a first filter function implementing the inverse characteristic of the optical frequency discriminator to provide a pre-compensation signal.

19. The vehicle of claim 18,
wherein the processor is configured to determine the laser phase noise compensation by further applying a series of a plurality of second filter functions to the pre-compensation signal, each second filter function describing the characteristic of the light transmission in a predefined distance from the output of the light detection and ranging system to generate distance specific compensation signals;
wherein the processor is further configured to apply the laser phase noise compensation by applying at least one of the distance specific compensation signals to the received light signal.

20. The vehicle of claim 17, further comprising:
at least one laser source configured to generate the coherent laser light.

21. (canceled)

22. (canceled)

23. (canceled)

24. (canceled)

25. (canceled)
